(19) United States
(12) Patent Application Publication
(10) Pub. No.: US 2025/0053138 A1
(43) Pub. Date: Feb. 13, 2025

(54) METHOD FOR TESTING AND PRODUCING BALANCE SPRINGS FOR TIMEPIECES

(71) Applicant: RICHEMONT INTERNATIONAL SA, Villars-sur-Glâne (CH)

(72) Inventors: David GACHET, Neuchâtel (CH); Kevin SOOBBARAYEN, La Rivière-Drugeon (FR); Susana TOBENAS, Boudry (CH)

(21) Appl. No.: 18/723,143

(22) PCT Filed: Nov. 30, 2022
(86) PCT No.: PCT/EP2022/083927

§ 371 Date: Jun. 21, 2024

(30) Foreign Application Priority Data
Dec. 22, 2021 (EP) 21216760.5
Jul. 18, 2022 (EP) 22185550.5

(51) Int. Cl. G04D 7/10; G04B 17/06

(52) U.S. Cl. CPC G04D 7/10; G04B 17/066

(57) ABSTRACT

Method for testing a balance spring or a balance spring blank arranged to form a balance spring, the balance spring being required to have at least one predetermined expected resonance frequency, the testing method including the following steps:
a. applying to the balance spring or balance spring blank, a vibratory excitation that varies over time in order to cover a predetermined frequency range,
b. identifying at least one characteristic of a resonance frequency of the balance spring or balance spring blank, such as a resonance peak, during, or in response to, the vibratory excitation over the predetermined frequency range,
c. subjecting the resonance frequency characteristic identified in step b. to a prediction machine in order to determine if the balance spring or balance spring blank is affected by a defect.

### TECHNICAL FIELD

The present invention relates to the field of testing and manufacturing of parts for timepieces. More particularly, the invention relates to a method for testing and manufacturing balance springs for timepieces, otherwise called resonators.

### PRIOR ART

The movements of mechanical watches are regulated by means of a mechanical regulator comprising a resonator, in other words an elastically deformable component, the oscillations of which determine the running of the watch. Many watches include, for example, a regulator comprising a balance spring as resonator, mounted on the axis of a balance wheel and set into oscillation by an escapement. The natural frequency of the balance wheel-balance spring pair enables the watch to be regulated and depends, in particular, on the stiffness of the balance spring.

More specifically, the frequency f of the regulating organ formed by the balance spring of stiffness R coupled with a balance wheel of inertia I is given by the formula:

$$f = \frac{1}{2 π} \sqrt{\frac{R}{I}} \qquad [ Equation 1 ]$$

The stiffness of the balance spring also defines its intrinsic vibratory characteristics, such as the natural frequency and the resonance frequencies. In the present application, the natural frequency of an elastic system (a resonator alone or a resonator-balance wheel pair) is the frequency at which this system oscillates when it is in free evolution, in other words without excitatory force. Furthermore, a resonance frequency of an elastic system subjected to an excitatory force is a frequency at which a local maximum can be measured in the amplitude of displacement for a given point of the elastic system. In other words, if the elastic system is excited by an excitation source at a frequency that varies over time, the amplitude of displacement follows a rising slope before this resonance frequency, and follows a descending slope after it, at any point not corresponding to a vibration node. Typically, during such a test, the recording of the amplitude of displacement as a function of the excitation frequency has a peak in the amplitude of displacement or resonance peak which is associated with or which characterises the resonance frequency.

The stiffness of a balance spring type resonator typically depends on the characteristics of the material from which it is made, as well as its dimensions and, in particular, the thickness (in other words the width) of its coils along its bar. More specifically, the stiffness is given by:

$$R = \frac{M}{φ} \qquad [ Equation 2 ]$$

with:
φ, the torsion angle of the spring, and
M, the restoring torque of the balance spring,
where M, for a bar of constant cross-section made of a specific material, is given by:

$$M = \frac{E ( \frac{{e}^{3} h}{12} φ )}{L} \qquad [ Equation 3 ]$$

with:
E, Young's modulus of the material used for the bar,
L, the length of the bar,
h, the height of the bar, and
e, the thickness or width of the bar.

The natural frequency of the regulating organ formed by the balance spring of stiffness R coupled with a balance wheel of inertia I is, in particular, proportional to the square root of the stiffness of the balance spring. The main specification of a balance spring is its stiffness, which must lie in a well-defined interval in order to be able to be paired with a balance wheel, which forms the inertial element of the oscillator. This pairing operation is indispensable for precisely regulating the frequency of a mechanical oscillator.

It is very important that the characteristics of the oscillator are as stable as possible, in order to have an equally stable running of the watch. The importance of magnetic fields in the modern environment, has for several years pushed horologists to use silicon balance springs, which are less sensitive to magnetic disturbances than metal balance springs.

Very advantageously, it is possible to manufacture several hundred silicon balance springs on a single wafer by using microfabrication technologies. In particular, it is known to produce a plurality of silicon resonators with very high precision by using photolithography and machining/etching methods in a silicon wafer. The methods for producing these mechanical resonators generally use monocrystalline silicon wafers, but wafers made from other materials can also be used, for example polycrystalline or amorphous silicon, other semiconductor materials, glass, ceramic, carbon, carbon nanotubes or a composite comprising these materials. For its part, the monocrystalline silicon belongs to the cubic crystal class m3m, for which the coefficient of thermal expansion (alpha) is isotropic.

Silicon has a highly negative value for its first thermoelastic coefficient, and consequently, the stiffness of a resonator made of silicon, and thus its natural frequency, varies strongly according to temperature. In order to at least partially compensate this disadvantage, documents EP1422436, EP2215531 and WO2016128694 describe a balance spring type mechanical resonator produced from a core (or two cores in the case of WO2016128694) made of monocrystalline silicon and for which the temperature variations in Young's modulus are compensated by a layer of amorphous silicon oxide (SiO2) surrounding the core (or cores), the latter being one of the rare materials having a positive thermoelastic coefficient.

When balance springs are produced from silicon or from another material by collective manufacture on a wafer, the final functional yield will be given by the number of balance springs, the stiffness of which corresponds to the pairing interval, divided by the total number of balance springs on the wafer.

However, the microfabrication steps, and more particularly etching, used in the manufacture of balance springs on a wafer, typically result in a significant geometric dispersion in the dimensions of the balance springs of a same wafer, and therefore a significant dispersion in their stiffnesses, notwithstanding that the etching pattern is the same for each balance spring. The measured dispersion in stiffness usually follows a Gaussian distribution. In order to optimise the manufacturing yield, it is therefore advantageous to centre the mean of the Gaussian distribution on a nominal stiffness value and also to reduce the standard deviation of this Gaussian.

Moreover, the dispersion of stiffnesses is larger still between balance springs of two wafers etched at different times according to the same method specifications. This phenomenon is shown in FIG. 1 where the stiffness dispersion curves Rd1, Rd2 and Rd3 for the balance springs on three different wafers are illustrated. In general, for each wafer, the distribution of stiffnesses R (with respect to the number of balance springs N having this stiffness) follows the normal or Gaussian law, each dispersion curve being centred on its respective mean value Rm1, Rm2 and Rm3.

Documents WO2015113973 and EP3181938 propose overcoming this problem by forming a balance spring having dimensions greater than the dimensions necessary for obtaining a balance spring with a predetermined stiffness, by measuring the stiffness of this balance spring formed by coupling with a balance wheel having a predetermined inertia, by calculating the thickness of material to remove in order to obtain the dimensions necessary for obtaining the balance spring with the predetermined stiffness, and by removing this thickness from the balance spring. Similarly, document EP3181939 proposes overcoming this problem by forming a balance spring having dimensions less than the dimensions necessary for obtaining a balance spring with a predetermined stiffness, by determining the stiffness of this balance spring formed by coupling it with a balance wheel having a predetermined inertia, by calculating the thickness of material to add in order to obtain the dimensions necessary for obtaining the balance spring with the predetermined stiffness, and by adding this thickness of material to the balance spring.

In this way, as illustrated in FIG. 2, notwithstanding the mean stiffness Rm1, Rm2, etc. of stiffnesses on a given wafer, the stiffness dispersion curve Rd1, Rd2, etc. can be re-centred with respect to a nominal stiffness value, Rnom.

By contrast, it may be observed that the manufacture of balance springs on a wafer can generate defects over several balance springs, which defects lead to large variations in vibratory behaviour with respect to a normally expected behaviour. In particular, it may occur that the coils remain in contact or are bonded to one another. Bridging phenomena may also be observed between coils due to impurities, or it may be observed that some parts of a balance spring remain in contact with other parts of the wafer. Obviously, these phenomena strongly affect the vibratory behaviour and can be considered as manufacturing defects which make one or more balance springs of a same wafer, unsuitable for use in a watch mechanism. Moreover, it should be noted that these defects are not easy to correct, and generally lead to the part in question having to be discarded. In particular, the fine corrections referred to above (creation of an oxide layer, addition or removal of material over the entire part) cannot be used to correct such point bonding defects or bridging defects of the part or its coils to one another or with the wafer which supports it.

The aim of the present invention is to propose an approach which is free from the above disadvantages which allows a production flow that is faster and/or has less risk of contamination, and/or a greater sampling, and/or an easier or faster detection of the balance springs of the wafer which have prohibitive defects for use in a watch mechanism.

### DISCLOSURE OF THE INVENTION

More precisely, a first aspect of the invention relates to a method for testing a balance spring or a balance spring blank arranged to form a balance spring, the balance spring being required to have at least one predetermined expected resonance frequency, the testing method including the following steps:
a. applying to the balance spring or balance spring blank, a vibratory excitation that varies over time in order to cover a predetermined frequency range,
b. identifying at least one characteristic of a resonance frequency of the balance spring or balance spring blank, such as a resonance peak, during or in response to the vibratory excitation over the predetermined frequency range,
c. subjecting the resonance frequency characteristic identified in step b. to a prediction machine in order to determine if the balance spring or balance spring blank is affected by a defect.

The method according to the above embodiment comprises a step consisting of identifying a characteristic that is indicative of a notable defect affecting the balance spring or blank in question. For example, if a divergence identified in the spectrum of vibratory frequencies obtained is greater than a predetermined threshold, then it is determined that the balance spring or the blank in question is usable in a watch mechanism. Hence, the method, with a simple measurement of the vibratory spectrum obtained in response to a vibratory excitation, can detect whether a defect affects the balance spring or the balance spring blank significantly, to the extent of making the part unusable and impossible to rework. Such a measurement (carried out on unitary or “bare” or “crude” finished or blank parts, in other words, for example, without finishing surface treatment, and/or not yet assembled) makes it possible to identify defects on the parts without analysis of the appearance, or unitary measurement, even before detaching them from the wafer and/or mounting them in an oscillating mechanism, which enables savings in time and resources. In other words, while still at the wafer stage, it is possible to categorise the balance springs or blanks into a first category of usable parts or parts for possible reworking, and a second category of defective parts to be discarded, for example.

The method according to the above embodiment comprises a step of vibratory excitation of the balance spring or balance spring blank, identification of a resonance frequency, in order to then deduce, by prediction, whether a defect affects the balance spring or the blank. There is no assembly with a balance wheel or another component, which saves time. Moreover, the measurement is carried out on the balance springs or blanks only, which limits the errors induced by other components or their assembly, as well as possible contamination. The measurement precision is improved because there are less sources of variability due to other components or contaminations. In other words, the balance spring or the balance spring blank alone is tested. The vibratory excitation is applied to the part or to the unitary blank, not coupled to any balance wheel, weight or oscillating system. The method enables testing of the unitary free parts, which provides advantages in terms of productivity gain (no assembly with an oscillating system), quality gains (no contamination of the parts), and a gain in precision (no error linked to other components of an oscillating system).

According to an embodiment, the defect may be:
one or more coils bonded or bridged to an adjacent coil, or to the rest of the wafer, such as the isolating support, for example,
a local or non-local porosity of the material or oxide,
an interface between a silicon core and an oxide layer with a void, a debonding, irregularities, etc.,
an irregular or interrupted thickness of oxide, etc.,
a defect or local lack of material, such as an infiltration defect for example,
a surplus of material, linked to a masking defect for example,
a heterogeneity of the material (silicon, silicon oxide),
a flatness defect (smoothing) of the lateral slices of the bar forming the balance spring,
a verticality defect of the lateral slices of the bar forming the balance spring (a taper or an undercut of the faces),
coils that are deformed, undulating or off-centre compared with the theoretical position, etc.

It should be noted that all the above defects are generally not rectifiable, and no subsequent treatment or geometric correction can be envisaged in the industrial context which must be profitable. Consequently, detection of such a defect leads to discarding of the identified part. In particular, the above defects cannot be compensated, masked or corrected at the oscillator level by adjusting, for example at the balance spring stud, an attachment length of the balance spring in the oscillator.

It should be noted that these defects are not obtained intentionally and therefore cannot be compared or assimilated, and do not encompass manufacturing the part (a balance spring made of silicon, for example) with overall and/or homogeneous dimensions that are intentionally higher or lower, in order to allow an overall correction of the stiffness and/or a subsequent oxidation in order to obtain, for example, a part with a target stiffness and/or thermo-compensation of the parts.

In other words, it should be noted that these defects are not and do not encompass a stiffness defect of the balance spring or balance spring blank, if for example such a defect is caused, in particular intentionally, by a part that is made too thick or too thin in order to then be able to correct the part (or all the parts of a same silicon wafer) as a function of a concrete measurement of the stiffness.

According to an embodiment, the vibratory excitation is applied to the balance spring or to the balance spring blank having a free end (typically the central collet). From a mechanical point of view, it can be schematically considered that the vibratory excitation is applied to a mass (located at the centre of gravity of the balance spring) connected to a reference (gripping pliers for a single balance spring, or the remainder of a substrate or a wafer for a blank, for example made of silicon and not detached) by a spring (the elastic part of the balance spring). The vibratory excitation sets the suspended mass in motion.

It should also be noted that if it is determined that the tested part must be isolated or discarded because of a defect, this can be done on the single part without dismantling anything.

The method according to the above implementation therefore makes it possible to test balance spring blanks during manufacture, limiting the risks of contamination or mounting errors. An identification of the defects at an advanced stage in the manufacture, is possible. The method according to the above implementation also enables the testing of completed balance springs, in order, for example, to carry out a final conformity check.

Of course, the frequency range of the spectra obtained depends not only on the source of vibratory excitation but also on the sensor of the measurement instrument used. Hence, the frequency range is linked both to the excitation frequency range and to the frequency range over which the instrument for measuring the amplitude of oscillation (vibrometer or other) is sensitive. However, the excitation frequency range will be chosen so as to include at least one resonance frequency of the tested balance spring or blank.

The predetermined resonance frequency which the finished balance spring must have, can be a target natural frequency or a target resonance frequency, or a target natural frequency range, or a target resonance frequency range defined by a tolerance around a target value.

In the method above, the characteristic of a resonance frequency is a characteristic of the oscillatory response measured over a predetermined frequency range, comprising at least one resonance frequency. Such a characteristic is typically identified after processing a raw measurement signal (for example measurement of displacement amplitudes, speeds or accelerations, of certain points of the balance spring or balance spring blank), the processing possibly including, for example, a Fourier transform for identifying resonance peaks and thus resonance frequencies.

In particular, the identified characteristic may be a resonance frequency value, a width of a resonance peak, an amplitude of a resonance peak, the presence or absence of a resonance peak, the shape of a resonance peak (closely spaced peaks, with several gradient inversions, etc.). The identification of the defect is thus based on the comparison between:
a characteristic (resonance frequency, width of a resonance peak, amplitude of a resonance peak, presence or absence of a resonance peak, shape of a resonance peak, etc.) taken from this spectrum of vibration frequencies of the balance spring or blank obtained in response to the vibratory excitation, and
the same characteristic (resonance frequency, width of a resonance peak, amplitude of a resonance peak, presence or the absence of a resonance peak, shape of a resonance peak etc.) taken from a reference spectrum, which may be a spectrum constructed from calibrated parts, test averages and/or simulations or numerical calculations.

According to an embodiment, step c. comprises at least one step of comparing a spectrum of vibratory frequencies of the balance spring or balance spring blank obtained in response to step a. with a reference spectrum, so as to determine if the characteristic identified in step b. is an abnormal characteristic diverging by a predetermined difference from the same characteristic of the predetermined expected resonance

According to the implementation above, in response to the vibratory excitation step of the balance spring or balance spring blank, the measurement of a vibratory response of the balance spring or of the blank, and the detection of an abnormal characteristic of a resonance frequency by comparison with the spectrum of vibratory frequencies obtained with a reference spectrum, then makes it possible to deduce by prediction whether a defect affects the balance spring or the blank.

According to an embodiment, in step a., the frequency range is applied simultaneously to a plurality of balance springs or balance spring blanks. The rapidity is improved, because the vibratory excitation can typically be imposed on a wafer supporting several hundred balance spring blanks, which were for example still attached to the wafer.

According to an embodiment, the frequency range is predetermined in order to encompass at least one frequency range:
centred on the predetermined resonance frequency, and
with an extent of at least 30% of the predetermined resonance frequency, in other words ±15% of the predetermined resonance frequency. For example, if the predetermined resonance frequency is 1 kHz, then the frequency range will be from 850 Hz to 1150 Hz.

According to an embodiment, the balance spring has at least two predetermined expected resonance frequencies, and the frequency range is predetermined in order to cover at least the two predetermined expected resonance frequencies. By covering or scanning a large range of frequencies, it is possible to measure a plurality of resonance peaks (or resonance frequencies), which can provide greater precision.

According to an embodiment, step a. comprises the use of a source, such as a piezoelectric source, which can induce or impose an acoustic excitation on a slice of a wafer supporting the balance spring blank, or preferably on, or even under, the balance spring or the balance spring blank to be specifically excited.

According to an embodiment, the acoustic source can be coupled to an excitation cone chosen in order to excite at least one balance spring or a balance spring blank. Preferably, if a wafer supports a plurality of balance springs blanks, then the acoustic source can be coupled with an excitation cone chosen in order to excite at least one portion of, and preferably all of, the balance spring blanks.

According to an embodiment, the acoustic source can be chosen and/or adjusted in order to generate the vibratory excitation that varies over time in order to cover the predetermined frequency range:
with an amplitude sufficient for generating vibrations of the balance spring or balance spring blank amplitude sufficient to be detected by the means for measuring displacement amplitude, speed or acceleration of at least one point of the balance spring or balance spring blank and/or
during a duration sufficient for deducing vibration spectra of the balance spring or balance spring blank.

According to an embodiment, the defect affecting the balance spring or the balance spring blank is a defect modifying the expected resonance modes, and step c. comprises a step consisting of searching for an abnormal resonance peak between two expected, and normally adjacent or consecutive, resonance peaks. The applicant has noticed that defects of bonded coils, lack of material, impurities linking together the coils, or other defects, can cause the balance spring or blank to have resonance modes that are not observed on compliant balance springs. The method is therefore intended to identify the presence of resonance peaks that are normally absent from the expected frequency spectrum. If the defect causes the generation of new resonance modes, then the method will make it possible to detect the defect, even if the other resonance peaks are correct.

According to an embodiment, the defect affecting the balance spring or balance spring blank is an attenuating or amplifying defect of the expected resonance modes,
and step c. comprises a step consisting of searching for an abnormal resonance peak with an amplitude that is different by at least 30% from an expected amplitude of an expected resonance peak. The applicant has noticed that defects of bonded coils, lack of material, or impurities linking together the coils can cause the balance spring or blank to have resonance modes that are notably different from those which can be observed on compliant balance springs. The method is therefore of interest in quantifying differences between the amplitudes of the resonance peaks in the obtained frequency spectrum and the same resonance peaks in the reference spectrum. Alternatively, the area under the obtained resonance peak can be calculated and compared with the area under the peak of the reference spectrum and it is possible to declare that there is a defect if the areas have a difference of, for example, 30%.

According to an embodiment, the method comprises a step d. consisting of categorising the defect identified in step c. For example, if the abnormal characteristic is the presence of an unexpected resonance peak, or if the abnormal characteristic is a strong attenuation of an expected resonance peak, then the prediction machine can identify and differentiate one defect from another, in order to categorise the defective parts. The categories of defects may be, for example, bonded coils, a material defect or else an unintended contact between the blank and the rest of the wafer.

According to an embodiment, step b. is based on a measurement over time of a displacement amplitude or speed or acceleration of at least one point of the balance spring or balance spring blank, preferably carried out at least partially during step a.

According to an embodiment, step b comprises:
a step of identifying a resonance frequency of the balance spring or balance spring blank as a function of an operational or modal deformation of at least one point of the balance spring or balance spring blank. An operational or modal deformation is typically defined by a displacement amplitude or speed, or even an acceleration and a direction of oscillation (outside of or in a particular plane) as a function of the excitation frequency.

According to an embodiment, the balance spring or balance spring blank is contained in a base plane, and step b comprises:
a step b′ of measuring a displacement amplitude, speed or acceleration of at least one point of the balance spring or balance spring blank in a direction perpendicular to the base plane, and/or
a step b″ of measuring a displacement amplitude, speed or acceleration of at least one point of the balance spring or balance spring blank in a direction contained in the base plane.

The measurements of displacements or speeds in several directions enable better identification of the peaks and resonance frequencies.

According to an embodiment:
for a first predetermined resonance frequency, only step b′ of measuring a displacement or speed of at least one point of the balance spring or balance spring blank in a direction perpendicular to the base plane is carried out, and/or
for a second predetermined resonance frequency, only step b″ of measuring a displacement or speed of at least one point of the balance spring or balance spring blank in a direction contained in the base plane is carried out.

Depending on the resonance frequency, the choice can be made to measure in one direction or another, so as to measure the largest possible displacements or speeds, in order to minimise the measurement error. More specifically, as a function of the geometry of the balance spring or balance spring blank, the mode of vibration (typically the direction of vibration) in response to the vibratory excitation can vary.

According to an embodiment, step b. comprises:
a step of identifying a resonance peak of the balance spring or balance spring blank as a function of a displacement amplitude or speed, of at least one point of the balance spring or balance spring blank.

According to an embodiment, the characteristic of the resonance frequency is identified on the basis of the width of the resonance peak, at half-height of the maximum value of the resonance peak. This treatment method makes it possible to limit the calculation errors which could be made if based solely on the identification of the frequency position of the peak defined by its maximum value.

According to an embodiment, the prediction machine can be a device which makes it possible to predict, thus to give or calculate in advance, based on one or more measured resonance frequencies, the presence of a defect, without coupling the balance spring to a balance wheel, and without performing tests other than the vibratory excitation of the parts alone. The output obtained by the user is information on the presence/nature of a defect or conformity/non-conformity which can be displayed or sent to the user of the testing method. It can be provided that the prediction machine:
is based on a mathematical model (for example a polynomial law linking one or more resonance frequencies with intrinsic parameters such as the stiffness,
uses a neural network to receive, as input, values or graphs taken from the vibratory measurement spectra in order to give, as output, the presence of a defect,
implements a system using artificial intelligence.

In other words, the prediction machine is not a regulated or self-regulated or feedback loop system for adjusting, during a regulating step of an oscillator, a resonance frequency in response to a measurement and to a comparison with a target value.

According to an embodiment, the prediction machine implements a classification carried out, for example, by a neural network in order to predict whether a defect affects the balance spring or balance spring blank.

According to an embodiment, the method comprises a preliminary step consisting of taking into account the material of the balance spring or balance spring blank, and adjusting a maximum amplitude of the vibratory excitation and/or a frequency range of the predetermined frequency range as a function of the material of the balance spring or balance spring blank.

According to an embodiment, the frequency range extends over a frequency range from 0 Hz to 100 kHz, preferably from 0 Hz to 50 kHz, more preferably from 0 Hz to 40 kHz, and very preferably from 10 KHz to 35 kHz. The applicant has observed that the precision of the prediction was better for the peaks or resonance frequencies located in a high frequency range. More specifically, focusing on the stiffness, its influence on the resonance frequency is stronger in high frequency ranges (for example between 10 KHz and 35 kHz), so that the sensitivity and precision are better over this particular range.

According to an embodiment, step a. and step b. are synchronised. Such a synchronisation gives the possibility of detecting a phase shift, or an attenuation, or a coupling, taking account of which can improve the precision of the prediction, or enable the vibratory excitation source to be adjusted or recalibrated.

According to an embodiment, if step c. determines that a defect affects the balance spring or the balance spring blank, then the method comprises at least one step consisting of identifying or isolating or reworking or discarding the balance spring or the balance spring blank.

A second aspect of the invention relates to a method for manufacturing a balance spring having at least one predetermined expected resonance frequency, comprising the steps consisting of:

A/forming at least one balance spring or balance spring blank having dimensions within predetermined tolerances necessary for obtaining the predetermined expected resonance frequency,

B/testing the balance spring or the balance spring blank according to the testing method of the first aspect.

According to an embodiment, the manufacturing method comprises a step consisting of:

C/identifying or isolating or reworking or discarding the balance spring or the balance spring blank formed during step A/, according to the defect identification of step c. of the first aspect.

According to an embodiment, the balance spring blank is formed on a wafer, with a plurality of other balance spring blanks.

A third aspect of the invention relates to a method for training a prediction machine for implementing step c. of the testing method of the first aspect of the invention, comprising the steps consisting of:
i—forming balance springs or balance spring blanks,
ii—applying to each of the balance springs or each of the balance spring blanks, a vibratory excitation that varies over time in order to cover a predetermined frequency range,
iii—identifying at least one characteristic of a resonance frequency of each balance spring or each balance spring blank during or in response to the application of the predetermined frequency range,
   iv′—installing a plurality of balance springs or balance spring blanks in an oscillating mechanism having a predetermined inertia, so as to measure a free oscillation frequency for each balance spring or balance spring blank,
   and/or
   iv″—modelling, in a simulation tool, a plurality of balance springs or balance spring blanks in an oscillating mechanism having a predetermined inertia so as to calculate a free oscillation frequency for each balance spring or balance spring blank,
   v—deducing at least one expected resonance frequency of the resonance frequency identified in step iii—, and/or of the free oscillation frequency measured in step iv′—and/or calculated in step iv″—;
   vi—supplying to the prediction machine, and for each balance spring or blank:
      the characteristic of the resonance frequency identified in step iii—;
      the same characteristic of the expected resonance frequency.

This learning phase can construct calibrated reference data for later comparison during a prediction/production phase with the search for defects. In particular, the learning makes it possible to obtain test data of reference parts or parts to be tested/simulated in parallel in order to construct, for example, a reference spectrum.

### BRIEF DESCRIPTION OF THE FIGURES

Other details of the invention will become more clearly apparent on reading the description which follows, made with reference to the attached drawings, in which:

FIG. 1 shows the uncorrected stiffness dispersion curves for the balance springs on three different wafers,

FIG. 2 shows the centring of the mean of the stiffnesses on one wafer, around a nominal value,

FIGS. 3A-3F are a simplified representation of a method for manufacturing a mechanical resonator, in this case a balance spring, on a wafer,

FIG. 4 represents a device enabling evaluation of the torque of a balance spring,

FIG. 5 schematically represents the implementation of the evaluation of the stiffness of a balance spring by vibratory analysis,

FIG. 6 represents an example of frequencies applied to a silicon wafer supporting balance spring blanks, in order to impose a vibratory excitation,

FIG. 7 represents an example of measurement of the amplitudes of displacement of a point of a balance spring blank, in response to the imposed frequency range of FIG. 6,

FIG. 8 represents, in detail, a resonance peak identified at a particular frequency in FIG. 7,

FIG. 9 represents the resonance peaks measured and superposed for the particular frequency of FIG. 8, for parts that are free of defects,

FIG. 10 represents an example of a prediction model constructed from data extracted from FIG. 9, relating to parts that are free of defects,

FIG. 11 represents a first example of measurements carried out for a set of parts comprising parts that are free of defects, and defective parts,

FIG. 12 represents a second example of measurements carried out for parts free of defects, and defective parts.

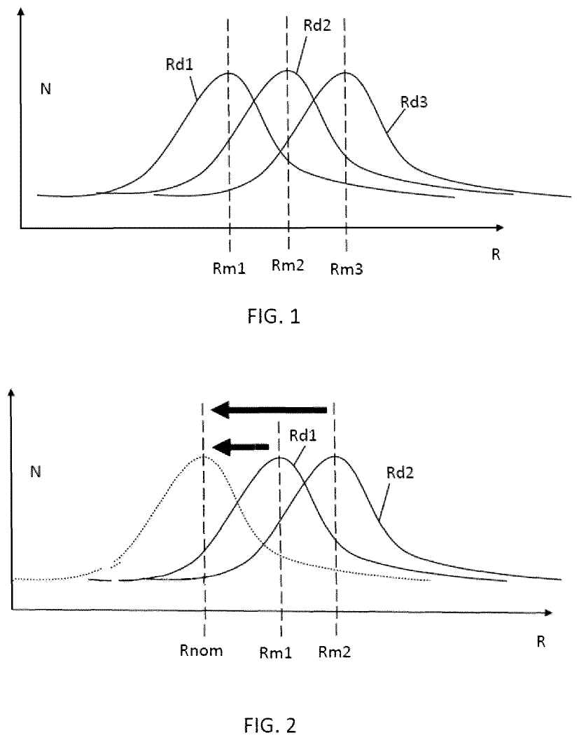

### EMBODIMENT OF THE INVENTION

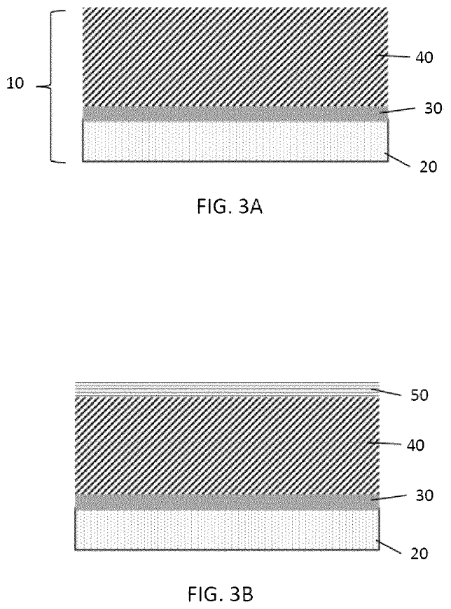

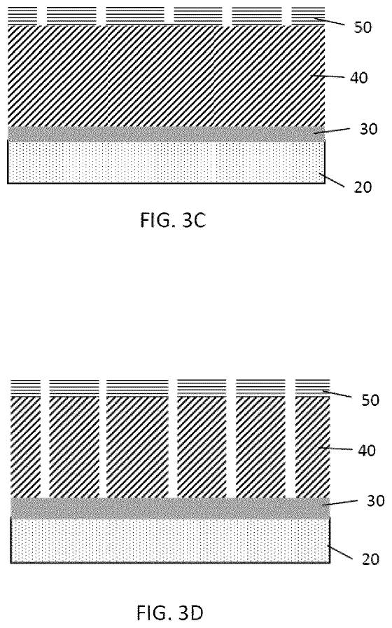

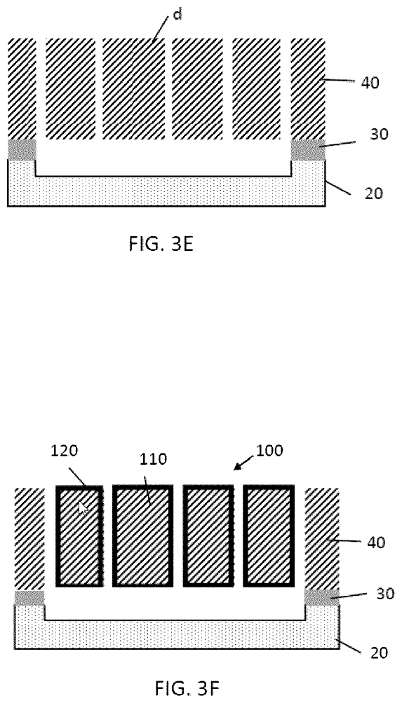

FIGS. 3A-3F are a simplified representation of a method for manufacturing a mechanical resonator 100 on a wafer 10. The resonator is, in particular, intended to equip a regulating organ of a timepiece part and, according to this example, is in the form of a silicon balance spring 100 which is intended to equip a balance wheel of a mechanical timepiece movement.

The wafer 10 is illustrated in FIG. 3A as a SOI (“silicon on insulator”) wafer and comprises a substrate or “handler” 20 bearing a sacrificial layer 30 of silicon oxide (SiO₂) and a layer of monocrystalline silicon 40. By way of example, the substrate 20 can have a thickness of 500 μm, the sacrificial layer 30 can have a thickness of 2 μm and the silicon layer 40 can have a thickness of 120 μm. The layer of monocrystalline silicon 40 can have any crystal orientation.

A lithography step is shown in FIGS. 3B and 3C. The term “lithography” means the set of operations enabling the transfer of an image or pattern on or above the wafer 10 to the latter. With reference to FIG. 3B, in this exemplary embodiment, the layer 40 is covered with a protective layer 50, for example of a polymerisable resin. This layer 50 is structured, typically by a photolithography step, using an ultra violet light source and, for example, a photomask (or other type of exposure mask) or a stepper and reticle system. This structuring by lithography forms the patterns for the plurality of resonators in the layer 50, as illustrated in FIG. 3C.

Following this, in the step of FIG. 3D, the patterns are machined, in particular etched, to form the plurality of resonators 100 in the layer 40. The etching can be carried out by a deep reactive ion etching technique (DRIE). After the etching, the remaining portion of the protective layer 50 is subsequently removed.

In FIG. 3E, the resonators are released from the substrate 20 by locally removing the sacrificial layer 30 or even by etching all or part of the silicon of the substrate or handler 20. A smoothing (not shown) of the etched surfaces can also take place before the release step, for example through a thermal oxidation step followed by a deoxidation step, consisting, for example, of wet etching using hydrofluoric acid (HF).

In the last step of the manufacturing method, in FIG. 3F, the coils 110 of the silicon resonator 100 are covered with a layer 120 of silicon oxide (SiO₂), typically through a thermal oxidation step in order to produce a thermocompensated resonator. The formation of this layer 120, which generally has a thickness of 2-5 μm, also affects the final stiffness of the resonator and therefore must be taken into account during the preceding steps, in order to obtain vibratory characteristics of the balance spring making it possible to obtain a particular natural frequency of the balance spring-balance wheel pair in a given watch mechanism.

As indicated above, at the stage preceding the production of the thermocompensation layer, the various resonators formed in the wafer generally have a large geometric dispersion between them and therefore a large dispersion in their stiffnesses, notwithstanding that the steps of forming patterns and machining/etching through these patterns are the same for all the resonators.

Furthermore, this dispersion in stiffnesses is even larger between the balance springs of two wafers etched at different times, even if the same method specifications are used.

Finally, it should be noted that during the manufacture, more point like manufacturing defects can occur. For example, during the machining step of FIG. 3D, material can remain between two adjacent coils. It is also possible to see parts for which material residues are still present between the coils or the substrate, contrary to what is shown in FIG. 3E. Material bridges can also be formed between two adjacent coils during the oxidation represented in FIG. 3F. Finally, contamination can also occur with debris or particles that get stuck between two coils or between the coils and the substrate. All these defects strongly affect the vibratory behaviour and cannot be corrected by adding or removing material over the set of parts, as it is known to do in the prior art.

The description above relates to silicon resonators 100, but glass, ceramic carbon-nanotube or even metal resonators are also possible. In particular, conventional steel balance springs can be tested. In this case, the metal balance spring is pinched or taken as a reference by a tool which positions it facing the emission source and the displacement measurement apparatus.

In known manner, the stiffness measurement of the balance spring can be carried out in a so-called static manner, in other words without setting the balance spring in oscillation, but by determining its torque. Reference can be made, for example, to document EP3654111.

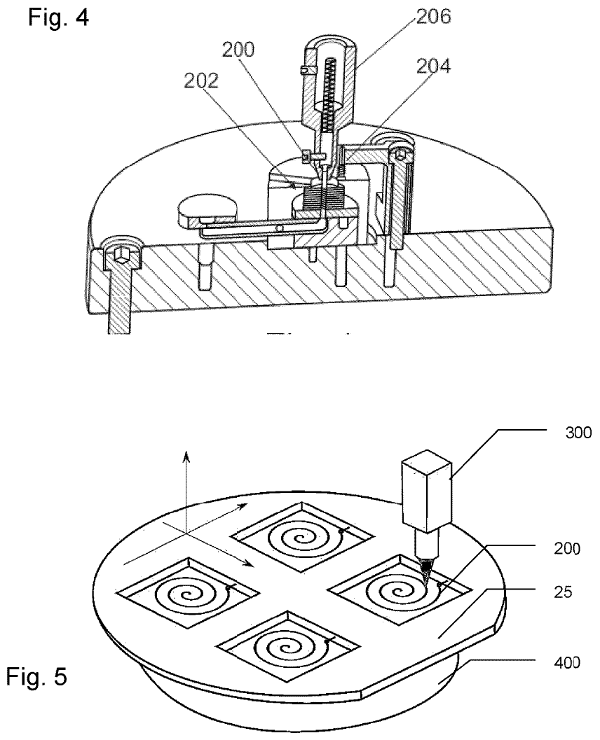

An alternative to the method described in this last document, consists of performing a torque measurement using a rheometer, such as marketed by Anton Paar. A device provided for this purpose is illustrated in FIG. 4. Advantageously, it makes it possible to dispose the balance spring 200 to be evaluated on a mount 202, and to position it in a manner where it can be fixed at its last coil by a retaining member 204. Once the last coil is fixed, the mount 202 is moved away from the balance spring 200 which is thus totally free from any elastic constraint. The rheometer head 206 is then positioned facing the collet of the balance spring. It has a non-circular counter-shape of the collet, but with a reduced size, which enables the rheometer head to engage in the collet, with a controllable precision, without coming into contact with the balance spring. The rheometer head is then set in rotation, in a direction of contraction of the balance spring. When the head comes into contact with the collet, it drives it and the rheometer measures the torque exerted by the elastic return of the balance spring, over a given angle. However, such a measurement remains a unitary measurement and requires a large handling time, with numerous risks of breakage, contamination, etc.

The present invention proposes determining, based on at least one characteristic, a resonance frequency of a sample of resonators 100 on the wafer in step 3E, and whether a defect is present on a part. If so, the present invention proposes identifying the part in question, without dismantling or measuring in a test sub-assembly, according to a more efficient method than the methods of the prior art.

Hence, the invention proposes determining at least one characteristic of a resonance frequency of a sample of resonators by vibratory measurement and applying a predictive method (for example a numerical model or a method of classification or categorisation) in order to link the result of said vibratory measurement to the identification of defects that are possibly present.

Thus the modal properties of the balance spring attached to the wafer are exploited. During a learning phase, and through an analytical and numerical approach, it is possible to put in place a prediction machine by establishing a predictive model linking manufacturing defects (bonding, bridging, contamination, etc.) to certain specifically chosen frequencies (natural frequency or resonance frequencies associated with a resonance peak or with a width at half-height).

Once the learning phase is completed (once the modes to be exploited and the excitation frequencies have been determined), it is possible to move to a prediction phase and to use the prediction machine by exploiting the predictive model in order to test the resonators of a produced wafer, in order to predict whether some parts are defective and, where appropriate, to identify them in order to discard them, for example.

Hence, it is possible to incorporate the testing method in a manufacturing method in order to separate, if necessary, the defective parts from parts that are free of defects and suitable for obtaining a particular and predetermined natural frequency of oscillation, once the resonators are each coupled to a balance wheel of a given watch mechanism.

### Vibratory Excitation

The measurement of the vibratory response of the resonators makes it possible to deduce at least one characteristic of a resonance frequency, for example a value of a resonance frequency. In detail, it is necessary to first apply a vibratory excitation to the wafer. Several options are provided:
a. Measurements in the frequency domain:
1—using a piezoelectric source (or any other source making it possible to induce or apply an acoustic excitation) on the slice of wafer, on or under the balance spring blank 200 to be specifically (preferably) excited, which excites at a particular frequency f₀ (continuous single-frequency excitation). In this alternative, the excitation is maintained.
2—Alternatively, it is also possible to use the piezoelectric source (or any other source enabling an acoustic excitation to be induced or imposed) on the slice of wafer, on or under the balance spring blank 200 to be specifically (preferably) excited which excites at a frequency that varies over time in order to cover a predetermined frequency range, for example from 0 to 100 kHz, preferably from 0 to 75 kHz, preferably from 0 to 50 KHz, preferably from 5 kHz to 50 kHz, and preferably from 10 to 35 kHz. The entire frequency range can be scanned or covered in a time interval ranging from a fraction of a second to several seconds. For example, the range of frequencies of the frequency range can be scanned or covered in less than 0.5 s, less than 1 s, or less than 1.5 s. In this alternative, the excitation frequency changes continuously.
b. Measurements in the time domain: using an excitation hammer (or any other source that can induce a pulsed acoustic excitation) on the slice of wafer, on or under the balance spring to be specifically (preferably) excited, which gives the shortest possible acoustic pulse (multifrequency pulse excitation). In this alternative, the excitation is temporary and not maintained.

Furthermore, the measurements can be carried out following a particular sampling, for example according to a sampling range of 4, 2 or 1 Hz. More specifically, the resolution for processing the acquisition data according to, for example, a Fourier transform, depends directly on the duration of this acquisition.

Furthermore, a sampling frequency of the signal can be chosen, of at least 100 KHz if the frequency range extends up to 50 kHz, for example.

In general, it can finally also be provided to change the direction of excitation, in other words the direction of the movements imposed by the source (vibrations can be imposed in one or more axial directions, and to change this or these directions over time). In the case where a wafer comprising a plurality of resonators is excited, the direction of the vibrations can be adjusted so as to point towards one or other of the resonators, depending on the displacement amplitude measurements described below.

Finally, it is possible to couple the acoustic source to a divergent cone, directed towards the resonators to be excited, and to regulate the acoustic source in order to emit an excitation signal with a sufficient amplitude to impose a vibratory excitation of the one or more resonators and having a sufficient amplitude to be detected and measured precisely by the chosen measurement instruments.

### Measurement of Displacement Amplitude, Speed or Acceleration

During the excitation, the amplitude and phase (with respect to the excitatory source) of oscillation in the 3 directions X, Y (in the plane) and Z (out of the plane) of the specifically excited balance spring are recorded via a suitable measurement means. In a non-limiting manner, the following possible measurement means can be cited:
Optical methods by interferometry:
a. By 3D Doppler effect (laser Doppler vibrometer),
b. Holography,
Stroboscopic optical methods,
High-resolution, temporal chromatic confocal profilometry,
Optical reflectometry:
a. Vibration analysis by beam deflection on a multi-dial detector or camera,
b. Analysis by time-correlated TCSPC analysis,
Acoustic methods by Doppler ultrasonography

FIG. 5 schematically represents a silicon wafer 25 on which a plurality of balance spring blanks 200 are formed. A vibratory excitation source 400 is coupled to the wafer 25, in order to impose a vibratory excitation. Consequently, each balance spring blank 200 will enter into vibration, and a laser vibrometer 300, here focused on a point of the right-hand balance spring blank 200, will be able to measure the amplitudes of vibration of the measurement point over time. The displacements in a direction perpendicular to the plane of the wafer 25 can be measured, but the displacements can also be measured in one or more directions contained in the plane of the wafer 25.

Once a particular point has been studied, the laser vibrometer 300 can be moved above another measurement point of the balance spring blank 200, or passed to another balance spring blank 200 of the wafer 25. Of course, the balance spring blank 200 can alternatively be displaced with respect to the laser vibrometer.

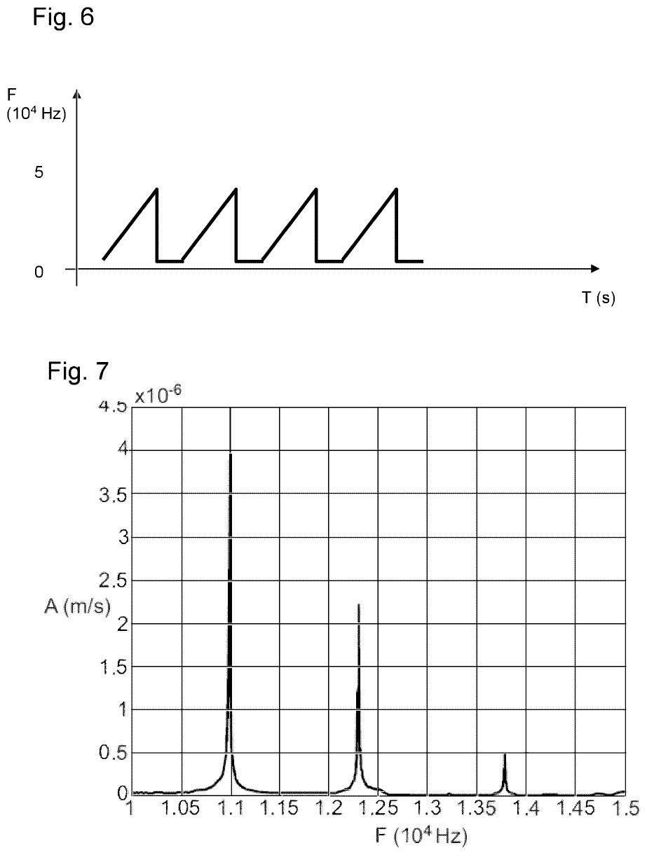

FIG. 6 represents an exemplary vibratory excitation over time. In the given example, the excitation frequency varies over time, between 0 Hz and 50 kHz, and a succession of rising edges can be imposed, each spaced apart by a rest period without excitation. For each measurement point on the balance spring blank 200, a plurality of rising fronts can be imposed (between 2 rising fronts and 60 rising fronts), each lasting between 0.5 s and 2 s, for example.

### Selection of Reference Points to be Measured

With regards to the displacement amplitude measurement, during the learning phase, a step consisting of identifying points of the resonator for which the vibratory response is significant can be provided. More specifically, in the case of a balance spring on which a vibration is imposed, especially if the frequency varies over time, the vibratory response will cause nodes to appear on the balance spring, in other words particular points of the balance spring for which the displacement amplitude is low or zero. If a displacement measurement is carried out on a point of the balance spring which proves to be a node at one or more particular frequencies, the identification of resonance frequency characteristics will be negatively affected.

Hence, it is advantageous to provide a preliminary step of measuring displacements at a plurality of predetermined points of the balance spring, for example at least ten predetermined points, preferably at least twenty predetermined points, and very preferably at least thirty predetermined points. The predetermined points can be selected, arranged on an orthonormal reference frame X-Y in the plane of the balance spring.

At the end of this preliminary amplitude measurement step on the predetermined points, resonance frequencies can be identified for each measurement point, and then a step of selecting reference points for which the displacement amplitude measurement during the excitation shows that there are no nodes of these resonance frequencies. In other words, the identified nodes have, at at least one resonance frequency, an amplitude of displacement that is zero or less than a first threshold peak value, and these points forming nodes are remote from the reference points to be considered for the later measurements. It can also be noted that the reference points differ as a function of the position of the balance spring blank 200 on the wafer 25.

Typically, it can be considered that at least two reference points will be selected, and preferably at least four reference points will be selected. In the case where the resonator has a radius Ra and is anchored or embedded on the wafer by its external pinning end, four reference points can preferably be chosen and located:
in a first zone at less than 0.20×Ra (for example on the central collet), or
in a second zone between 0.05×Ra and 0.30×Ra (for example on the second coil starting from the collet), or
in a third zone between 0.35×Ra and 0.65×Ra (for example on a coil situated in the middle of the balance spring), or
in a fourth zone between 0.65×Ra and 0.85×Ra (for example on a coil situated three quarters of the way along the balance spring).

Hence, the reference points are separated from the portion anchored on the wafer and naturally have a significant capacity for oscillatory displacement, which ensures better precision of the displacement measurement.

Furthermore, displacements can also be measured for a point of the body of the wafer, and/or for a point of the excitation source, in order to identify or measure, for example, a phase shift or vibratory attenuation, or even a resonance resulting from a vibratory coupling, or of the wafer. These complementary measurements can ensure that the identified peaks are indeed those of the balance spring alone. The displacement amplitude measurements and the vibratory excitation can also be synchronised.

Alternatively, it is possible to only measure the displacements/movements/vibrations on a particular point, preferably situated on a zone of the part that does not deform. In particular, it can be provided to direct the measurement on a point of the collet of the balance spring or balance spring blank. More specifically, the collet can be considered non-deformable during the vibratory excitation and all the points of the collet have similar displacements/movements/vibrations. Consequently, a small error in location of the measurement point on the collet will have little consequence for the final result. Furthermore, by having chosen a particular measurement point on the part, it is possible to identify and choose a particular frequency range for conducting the stiffness prediction.

An embodiment in which a plurality of parts, still attached to a substrate or to a tool, are tested in series, can include:
a step of capturing an image of the parts to be tested,
a step of analysing the image in order, for example, to recognise each part type, and/or the position of each part,
a step of selecting one or more points to be measured for each part, and/or selecting a vibratory excitation spectrum to be imposed for each part and/or each point selected,
for each part to be tested, a step of positioning the substrate or the tool supporting the parts to be tested, in a vibratory excitation and measurement apparatus. According to this implementation, the excitation and measurement in the case of a wafer which still carries the balance springs blanks can be automated:
one or more images of the wafer are taken,
an automatic image analysis is carried out in order to know at least the X-Y position of each part (recognition of the part type or model can also be performed),
as a function of the position and/or of the recognised part type, particular pre-established measurement points are identified or selected (for example on the collet); a particular excitation cycle can also be selected as a function of the part type or of a particular point,
with, for example, a tool which carries the wafer and which comprises a table that can move in X-Y, each balance spring blank is automatically successively placed opposite the excitation source and the measurement apparatus in order to be tested by targeting the correct measurement point and by applying the correct excitation specification.

According to an embodiment, as a function of the measurement point selected on the part to be tested and/or as a function of the excitation frequency, and/or as a function of the model of the part to be tested, a step can be provided consisting of giving a particular orientation to the excitation direction and/or to the measurement direction. For this purpose, an excitation direction (or an axial direction of the excitation source) can be chosen that is perpendicular to the part to be tested, in order to maximise the displacements perpendicular to the plane formed by the part at rest. An excitation direction (or an axial direction of the excitation source) can be chosen which is inclined with respect to the part to be tested, in order to maximise the displacements contained in the plane formed by the part at rest. With regard to the measurement, a measurement direction (or an axial direction of a laser beam of the measurement apparatus) can be chosen perpendicular to the part to be tested in order to maximise the measurement precision of the displacements perpendicular to the plane formed by the part at rest. A measurement direction (or an axial direction of a laser beam of the measurement apparatus) can be chosen, inclined with respect to the part to be tested, in order to maximise the measurement precision of the displacements contained in the plane formed by the part at rest.

According to an embodiment in which a plurality of parts are attached to a substrate such as a wafer, a sampling can be carried out by detaching one or more parts in order to test them singly, and by introducing a particular excitation frequency to be applied, and/or a particular measurement point to be used, and/or a particular range of the vibratory spectrum to take into account. In other words, this preliminary sampling makes it possible to test single parts under good conditions (measurement errors and interference are limited) in order to choose the best test conditions for the parts which remain integral with the substrate.

### Determination of Vibratory Characteristics

There are then a plurality of scenarios depending on the range chosen beforehand for the excitation:

A. Measurements in the frequency domain
1—Alternative with Maintained Excitation:
i. Integrate the amplitude and the oscillation phase over time, for a sufficiently long time to have good spectral resolution at the excitation frequency f₀,
ii. Offset the oscillation frequency by delta f in order to excite at frequency f₀+Δf and repeat the integration step i,
iii. Reconstruct the amplitude and oscillation phase spectra, as a function of the excitation frequency (possibly with a plurality of peaks at a plurality of frequencies).
   2—Alternative with Excitation for which the Frequency Varies Over Time:
i. Record the oscillation amplitude and phase with respect to time over the course of the frequency scanning of the frequency range,
ii. Repeat step i—at least once, preferably at least three times,
iii. Reconstruct the amplitude and oscillation phase spectra, as a function of the excitation frequency (possibly with a plurality of peaks at a plurality of frequencies).
   b. Measurements in the Time Domain:
i. Record the displacement over time of the coil in X, Y and Z over a sufficiently long duration so as to obtain a sufficiently representative signal, for example several seconds.
ii. It can be chosen to record the signal in order to make it into a reference signal to be compared with other signals measured on other parts. It can also be chosen to perform signal processing of the Fourier transform type, in order to identify resonance frequencies in the recorded signal.

Consequently, at least one resonance peak can be identified for each excited resonator, and it is proposed to determine the resonance frequency not on the basis of the apex of the resonance peak, in other words the maximum amplitude, but rather over a region of the curve located between 25% and 75% of the maximum amplitude value of the resonance peak, for example based on its width at half-height. More specifically, this processing method which focuses on a portion of the curve between 25% and 75% of the maximum amplitude value of the resonance peak can limit errors due to the singularity of the maximum amplitude point and to the approximation calculation for reconstructing the apex portion of the resonance peak. The region of the curve located between 25% and 75% of the maximum amplitude value of the resonance peak has a better precision than the portion greater than 75% (typically the peak), which offers a better precision on the exact resonance frequency determined. It is possible to take, for example, the midpoint of the segment connecting the two points at half-height of the resonance peak, in order to determine the resonance frequency associated with the peak in question.

FIG. 7 represents an example of a vibratory spectrum for a point of a balance spring blank 200 of FIG. 5 that is free from defects, reconstructed from displacement amplitude measurements of the measurement point considered in response to the vibratory excitation of FIG. 6, between 10 KHz and 15 kHz. The presence of three amplitude peaks at approximately 11 kHz, 12.3 kHz, and 13.7 kHz, can be noted. Although this is not shown, it is typically possible to identify between 10 and 30 amplitude peaks if the vibratory excitation scans a frequency range extending between 0 Hz and 50 KHz. Each amplitude peak has a resonance frequency, and the maximum amplitudes vary strongly.

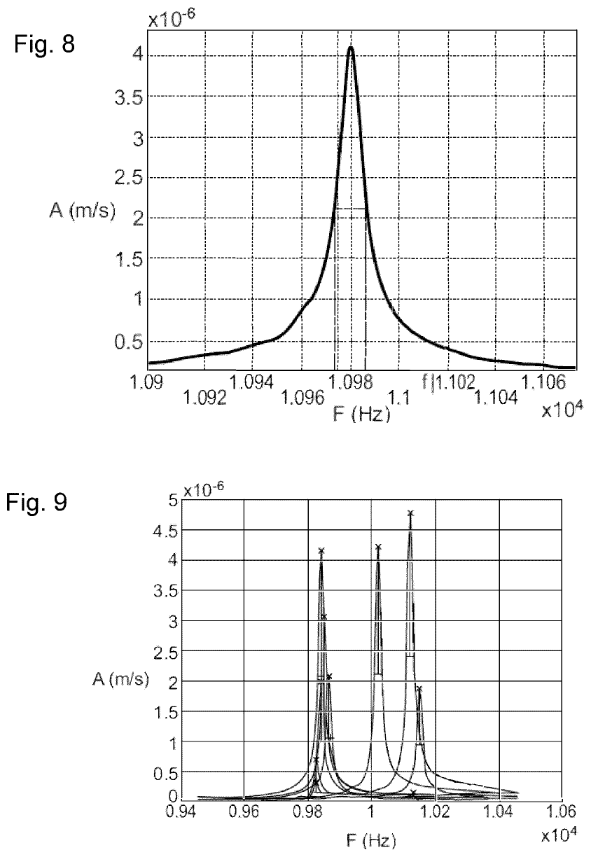

FIG. 8 represents, in detail, the processing that can be performed on an amplitude peak for a part that has no defect, that at 11 kHz for example. The aim is to find the resonance frequency and to give it as precise a value as possible. Instead of basing this processing on the maximum value of the peak, the applicant has realised that better precision can be attained by determining the length of the segment connecting the rising portion and the descending portion of the curve, at half-height of the peak. The resonance frequency typically being the mid-value of this segment. However, an interpolation can be carried out over the points neighbouring the resonance peak in order to improve the precision, and to shift the point chosen on the segment, which will not be the midpoint, in particular if the actual position of the resonance peak is shifted, for example, because of the chosen sampling frequency.

FIG. 9 represents, for the example of an amplitude peak at approximately 10 KHz, the amplitude peaks constructed for around ten balance spring blanks 200 that are tested and free from defects. It can be noted that from one balance spring blank to another, the frequency position of the amplitude peak varies (approximately from 9.8 kHz to 10.02 kHz), and that the maximum displacement amplitude varies in a ratio of approximately 1 to 5. Since the apices of the amplitude peaks are not truly symmetric, it may be judicious to determine the resonance frequency on the basis of the width of the peak at half-height. The width of the peak at half-height can also be used to determine a damping, and to compare this damping with a reference value.

For these tests of FIG. 9, it was possible to deduce the following resonance frequencies:

| Spring balance number | Resonance frequency (Hz) |
|---|---|
| 2 | 9824 |
| 9 | 9824 |
| 3 | 9840 |
| 8 | 9840 |
| 7 | 9848 |
| 4 | 9863 |
| 10 | 10020 |
| 5 | 10121 |
| 1 | 10129 |
| 6 | 10148 |

Determination of the Stiffness and/or Actual Dimensions of the Bar of the Resonators Tested

In order to establish a predictive model which can receive, as input, the vibratory characteristics (typically a resonance frequency) and give, as output, a stiffness and/or a dimensional correction, it is necessary, during the learning phase, to supply data relating to the actual stiffness and/or dimensions of the bar of the tested resonators. For this purpose, a natural frequency of a balance spring-balance wheel system can be practically measured in an environment similar to that of a particular watch mechanism.

Two alternatives can be implemented. According to a first alternative, it is possible to couple a predetermined balance wheel on the resonator still attached to the wafer, and to measure a natural frequency of oscillation of the resonator-balance wheel pair in order to compare this natural frequency with an expected natural frequency and, above all, to calculate the actual stiffness or the actual dimensions, on the basis of equations 1 to 3 above. According to a second alternative, the manufacture of the tested resonators can be finished, in order to mount or couple them with a balance wheel, individually in order to again measure here a natural frequency of oscillation of the resonator-balance wheel pair.

In the two alternatives above, an intermediate step can be included for determining the stiffness of each resonator, and then determining the actual dimensions of the bar of the tested resonators. In other words, it is possible to determine the natural frequency or a resonance frequency and then the stiffness or the dimensions of the bar of the resonator by analysing the free oscillations of a balance spring coupled with a reference balance wheel. In this approach, a laser pointed at the arm of the balance wheel or at the balance spring carrier, records the time of passage of the arms of the balance wheel or of a locating pin. Then, from this, the period is deduced, then the frequency and finally the stiffness. The data collected are essentially point clouds of times of passage.

More specifically, in order to evaluate the stiffness of a balance spring on the wafer, a plurality of solutions are proposed, such as described, in particular, by M. Vermot et al., in Traité de construction horlogère (2011) on pages 178-179. For example, a dynamic evaluation can be carried out, by coupling the balance spring to a reference balance wheel for which the inertia is known. The measurement of the frequency of the assembly makes it possible to deduce the stiffness of the balance spring, in a precise manner. This evaluation can be carried out on the wafer or by detaching the balance spring from the wafer. The references and prior art given above provide details on this method

Similarly, the stiffness can also be deduced from a measurement of the reaction torque at the collet using a rheometer. The signal required represents the change over time in the torque as a function of the amplitude. The analysis of the slope of this curve for low amplitudes (linear portion) makes it possible to deduce the stiffness, and then the dimensions of the bar of the resonator. The dimensions of the bar of the balance spring can then be determined.

On the other hand, a natural frequency and/or a resonance frequency and/or the stiffness can be estimated by simulation, for each resonator tested on the wafer. For this purpose, dimensional measurements can be performed for each tested resonator in order to reconstruct the resonator by numerical modelling, in order to simulate, by numerical calculation, its vibratory response to the spectrum imposed, and to further find the stiffness of the resonator.

A high-resolution 3D X-ray tomography approach would enable point clouds to be extracted, giving the 3D material density of the balance springs, and, using appropriate image reconstruction, a mapping of the section of the balance spring. These different types of data make it possible to deduce the dimensions of the bar and to estimate the stiffness of the balance spring by a geometric approach.

Another approach consists in analysing the forced oscillations of a balance spring on a reference balance wheel with an escapement. A laser measurement of the times of passage of the arms of the balance wheel (point clouds), as described above, enables the frequency to be measured and the stiffness to be deduced from it. An alternative is possible, based on an acoustic acquisition (Witschi-type microphone) which records the impacts of the various operating phases of the escapement/anchor system. The measured data are either point clouds of times of passage of the arms of the balance wheel, or the change over time in the level of acoustic pressure. These types of experimental data make it possible to deduce the period, then the frequency, then the stiffness and finally the dimensions of the bar of the resonator.

Returning to the test discussed above in FIG. 9, a measurement of the stiffness has been carried out by coupling each balance spring blank 200 to a reference balance wheel, and it was possible to deduce the stiffnesses below:

| Spring balance number | Measured stiffness (10⁻⁷ N · mm) |
|---|---|
| 2 | 3.89 |
| 9 | 3.88 |
| 3 | 3.92 |
| 8 | 3.90 |
| 7 | 3.91 |
| 4 | 3.95 |
| 10 | 4.111 |
| 5 | 4.135 |
| 1 | 4.119 |
| 6 | 4.196 |

### Establishing the Predictive Model

In order to be able to detect defects, reference data must first be established or constructed, such as a reference spectrum for example. During the learning phase, the amplitude measurements of oscillations are carried out on physical resonators, and resonance frequencies are identified. In order to be able to subsequently link the resonance frequencies measured on resonators to stiffnesses and/or dimensional (thickness) corrections to be made, it is necessary to provide a correlation phase during which a predictive model is constructed.

The operations described above (vibratory measurements, identification of resonance peaks, bandwidth at half-height and its midpoint or corrected value, determining the stiffness and/or dimensions of the bar) enables the supplying of a database able to relate the position of the balance spring on the wafer, spectra or oscillation periods or bandwidth at half-height and its midpoint or corrected value with the effective stiffnesses and/or dimensions of the bar of the balance spring. As seen above, this database can be constructed from numerical simulations on a balance spring finite element model. These simulations can generate spectrum or reference oscillation periods associated with the stiffnesses. This database can also be supplemented by experimental measurements, by measuring vibration spectra, oscillation periods and the positions of balance springs on the wafer, as well as their associated stiffnesses. One of the advantages of this approach resides in the fact that the learning database is enriched over the course of the tests. This can make it possible to have an adaptive model depending on the wafers and the balance springs and contributes to the reduction in the standard deviation in stiffness on the wafers.

This database can be used to construct a predictive model, and a plurality of solutions are offered.

A numerical model can be constructed, for example a polynomial model, in order to calculate, as a function of a value of resonance frequency, an actual thickness, a dimensional correction or an actual stiffness.

It is also possible to carry out a categorisation by carrying out a k-means partition of the input data (the results of the vibratory measurements, typically the frequency of the resonance peaks) and output data (stiffness, and/or dimensions of the bar of the resonator) and linking them together in order to establish a correspondence.

It can also be provided to process the images of the resonance peaks using a neural network, for example a perceptron, in order to carry out a classification according to stiffnesses or dimensions of the bar, the classes being able to be defined by value increments.

In summary, the learning phase comprises a test phase (excitation of resonators with measurement of the vibratory characteristics in order to reconstruct a vibratory spectrum and to identify resonance frequencies). A measurement phase of the stiffnesses and/or dimensions of the bar of the resonators is also carried out. Once the input data (the resonance frequencies) and the output data (the stiffnesses and/or the dimensions of the bar) for a significant sample are available, the construction phase of the predictive model can be carried out.

Returning to the example considered and described in relation with FIG. 9, the data collected are the following:

| Spring balance | Resonance | Measured stiffness |
|---|---|---|
| number | frequency (Hz) | (10⁻⁷ N · mm) |
| 2 | 9824 | 3.89 |
| 9 | 9824 | 3.88 |
| 3 | 9840 | 3.92 |
| 8 | 9840 | 3.90 |
| 7 | 9848 | 3.91 |
| 4 | 9863 | 3.95 |
| 10 | 10020 | 4.111 |
| 5 | 10121 | 4.135 |
| 1 | 10129 | 4.119 |
| 6 | 10148 | 4.196 |

Linear regression modelling has been carried out on the above data for the first six lines, and the following relationship could be established:

$$R = 0.0015 F - 10.894 ,$$

With
R for the stiffness in 10⁻⁷ N·mm
F for the resonance frequency in Hz.

The stiffness can therefore be predicted and compared with the actual stiffness measured, as shown in the table below, with, for the first six lines, the data used to build or train the linear regression and, for the last four lines, a prediction only:

| | | R (10⁻⁷ | R (10⁻⁷ | |
|---|---|---|---|---|
| | | N · mm) | N · mm) | |
| No. | F (Hz) | measured | predicted | deviation |
| 2 | 9824 | 3.89 | 3.84 | −1.20% |
| 9 | 9824 | 3.88 | 3.84 | −1.10% |
| 3 | 9840 | 3.92 | 3.87 | −1.40% |
| 8 | 9840 | 3.9 | 3.87 | −0.90% |
| 7 | 9848 | 3.91 | 3.88 | −0.70% |
| 4 | 9863 | 3.95 | 3.9 | −1.20% |

Test

| | | | | |
|---|---|---|---|---|
| 10 | 10020 | 4.111 | 4.136 | 0.60% |
| 5 | 10121 | 4.135 | 4.288 | 3.70% |
| 1 | 10129 | 4.119 | 4.3 | 4.40% |
| 6 | 10148 | 4.196 | 4.328 | 3.20% |

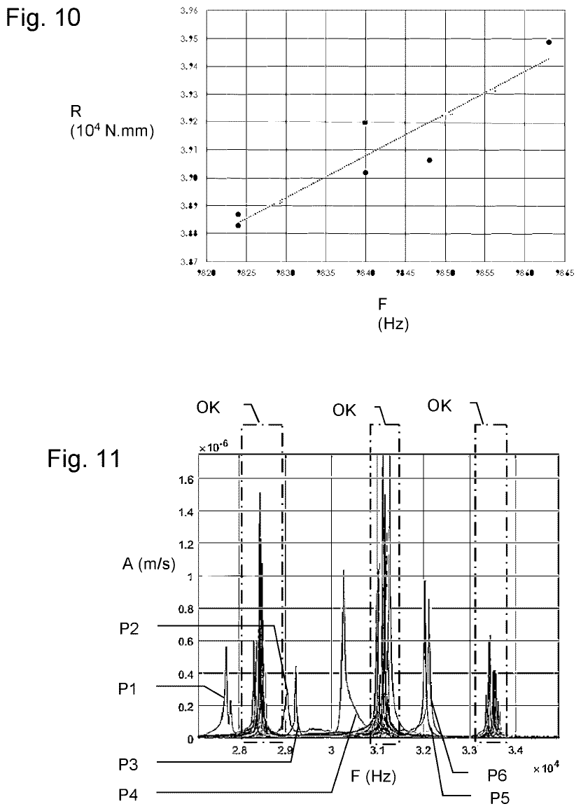

A maximum error of 4.40% could be measured, and FIG. 10 shows the linear progression straight line for the values from the first six lines.

It can be seen that it is advantageous to verify that the established predictive model has a good sensitivity, in other words that for two different input values, the model gives two distinct output values. The applicant has observed that the sensitivity of the predictive model was not the same for all the resonance peaks. In particular, referring to the predictive formula established and represented in FIG. 10, the leading coefficient is 0.0015 10⁻⁷ N·mm/Hz. On the one hand, the applicant has observed that the leading coefficient could be larger for high resonance frequencies, which provides better prediction sensitivity, in order to predict distinct stiffness or dimensional correction values, even based on close resonance frequency values. It is advantageous to provide, during the learning phase, a step of comparing the prediction sensitivity p in order to verify/confirm that it is preferable to consider and choose certain resonance peaks at high frequencies (for example above 5 kHz) in order to then predict, as precisely as possible, a stiffness and/or a dimensional correction as a function of the measured vibratory response.

On the other hand, the applicant has also observed that even for close resonance frequencies, the resonance modes (in particular the deformation modes and/or displacement modes of the resonators) can differ significantly, which can also affect the sensitivity of the stiffness and/or dimensional correction prediction. It is advantageous to provide, during the learning phase, a step of comparing the sensitivity of the prediction in order to choose to later consider such and such a resonance frequency and not another, in order to predict, as precisely as possible, a stiffness and/or a dimensional correction as a function of the vibratory response.

From the above remarks relating to the study of the sensitivity of the prediction, it can be provided, during the learning phase, to classify the various resonance peaks identified according to the prediction sensitivity of the stiffness and/or of the dimensional correction. It can then be provided to define the excitation frequency range (which will be applied during a pure prediction phase) in order to include at least one or more peaks or resonance frequencies which give the best sensitivity. Hence, imposing a variable vibratory excitation over the frequency range thus predetermined, will guarantee being able to make a precise prediction for the identified resonance peak or predictions for each of the identified resonance peaks, which intersect or reinforce one another.

In general, the learning phase makes it possible to choose either resonance peaks at high frequencies and/or resonance peaks which correspond to particular resonance modes that made it possible to predict precise and reliable values, and the frequency range will be predetermined to include at least one resonance peak and preferably a plurality, in order to be able to make either a single prediction that is as precise as possible, or a plurality of predictions (one per resonance peak judged interesting) in order to then carry out cross checks, averages or even adjustments of the predicted values.

It is also possible, for example, to predict a plurality of stiffness or dimensional correction values based on a plurality of peaks or resonance frequencies, and then to calculate a definitive value, by performing, on the basis of predicted values, a weighted average by attributing weights to each predicted value, each weight being determined as a function of the sensitivity identified for each corresponding peak or resonance frequency.

Alternatively and preferably, it is possible to have only a single model which takes all the peaks or resonance frequencies as input and which returns the stiffness or the dimensional correction, the learning phase of the model being used to precisely calculate the weightings on the input peaks or resonance frequencies.

### Prediction Phase

Once the learning phase is ended, it is possible to go to a prediction phase, for example during a method for testing resonators. Typically, the testing method can be performed on balance spring blanks produced on a wafer and still attached to this wafer, so as to estimate the stiffness and/or the dimensions of the bar of the balance springs of the sample, in order to determine whether a dimensional correction is to be applied.

Once the model is trained, the testing procedure to be deployed can be as follows:
1) Identifying the position of the balance spring on the wafer, vibratory measurement of the spectra or oscillation period (as described above),
2) Predicting the stiffness and/or dimensions of the bar of the balance spring by application of the predictive model,
3) Determining whether a dimensional correction is necessary for attaining the natural frequency or target stiffness.

During the testing method, it is also possible to quantify the exact correction to be applied, so that the manufacturing method can additionally include the above test:
1) Knowing the effective stiffness of the balance spring estimated according to the model and the target stiffness and/or the target dimensions of the bar: applying the necessary correction dose.

Repeating step 1) and step 2) of the test method in order to test the stiffness/dimensions of the balance spring and to confirm that the target values are reached, within a tolerance threshold, or repeating these steps and the dimensional correction until the stiffness/dimension predicted by the model reaches the target values.

### Sampling

It is known to produce several hundred balance springs on a wafer and that the dimensions of the bar of the balance springs produced, can vary according to the regions of the wafer. If the stiffness evaluation can be carried out on a single balance spring, in practice it will be carried out on a sample of balance springs, distributed over the wafer.

Starting from the evaluations carried out, the corrections can be carried out for the entire wafer in a homogeneous manner, or even differentiated by region, if the obtained results vary from one balance spring to another. It is thus possible to reduce the standard deviation of the dispersion of stiffnesses. Furthermore, if the stiffnesses are known for all the balance springs by application of the model, the optimum correction enabling the overall dispersion to be reduced can be determined.

It can even be envisaged to go to an evaluation of all the balance springs of the wafer, in particular with a vibratory evaluation, because this is very quick to perform and can enable the method to be automated.

Although the examples above have been given mainly on the basis of a manufacture of balance springs having larger dimensions of the installed bar than the dimensions of the target bar, it can also be provided to produce balance springs having smaller dimensions of the initial bar than the dimensions of the target bar. The correction step then consists of adding the material, as described, for example, in the above-mentioned document EP3181939.

The method, consisting of identifying resonance frequencies by imposing a vibratory excitation on the balance spring blanks only, makes it possible to rapidly obtain measurement data, without having to perform, for example, operations for mounting a balance wheel, while limiting the measurement errors because only the balance spring blank is tested (there is no error that can be linked to the balance wheel, such as its mass, its installation position, etc.).

The applicant has also observed that the prediction phase can also, or alternatively, be a method for detecting significant defects on the parts, such as coils that are bonded or bridged together or onto the substrate. FIG. 11 shows, for example, frequency spectra measured on blanks of a wafer, including corrected parts (the resonance peaks of which are surrounded by rectangles with dash-dot mixed lines and marked “OK”), and incorrect parts marked P1, P2, P3, P4, P5 and P6.

More specifically, during the test, each frequency spectrum obtained in response to the vibratory excitation is connected to a particular part by traceability, and an inspection of each of the parts having generated resonance peaks P1 to P6 turns out to have a defect. Consequently, the comparison of each of these frequency spectra with the reference spectrum previously established during the learning phase, makes it possible to observe a significant deviation or divergence, which reveals a defect which allows the part in question to be discarded.

In this example, the method comprises a step of searching for and identifying excess resonance peaks in relation to an expected frequency spectrum. Such an excess peak can be detected if it exceeds an expected noise level by at least 30%. In other words, the presence of a resonance peak between two normally adjacent or consecutive resonance peaks forms an abnormal characteristic of a resonance frequency and makes it possible to identify a balance spring or blank with a bonded coils defect. Such defects cannot be easily corrected, so the part is identified and in principle discarded.

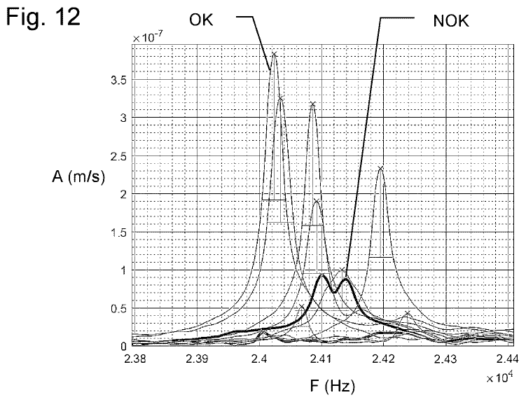

FIG. 12 shows another example or type of abnormal characteristic with respect to a reference spectrum. More specifically, on the expected resonance frequency at around 24.1 KHz, among the curves with a single resonance peak (marked “OK”), the presence of the curve shown in bold can be seen, with a “double peak” resonance. In this case, in order to detect a defect, the method must search for two apices or three points of change of slope in the portion of curve located at half-height or above half of the recorded maximum value (in place of a single maximum or single change of slope for a part free from defects).

Hence, by searching for peaks of the reference spectrum that are normally absent, as in FIG. 11, or resonance peaks that are notably different from the expected peaks, as in FIG. 12 (with several changes in slope or maximums, or even a notably different amplitude), parts can be identified which have a defect involving bonded coils, bridging with the substrate, heterogeneity of the material, residual deformation of the balance spring, microcracks or even inadvertent contamination. Each frequency spectrum obtained is assigned or linked by traceability to the parts tested, so that it is possible to identify the parts in question and isolate or discard them.

1. A method for testing a balance spring or a balance spring blank arranged to form a balance spring, the balance spring being required to have at least one predetermined expected resonance frequency, the testing method including the following steps:
a. applying, to the balance spring or balance spring blank, a vibratory excitation that varies over time in order to cover a predetermined frequency range,
b. identifying at least one characteristic of a resonance frequency of the balance spring or balance spring blank, such as a resonance peak, during or in response to the vibratory excitation over the predetermined frequency range,
c. subjecting the resonance frequency characteristic identified in step b. to a prediction machine in order to determine if the balance spring or balance spring blank is affected by a defect.

2. The test method according to claim 1, wherein step c. comprises at least one step of comparing a spectrum of vibratory frequencies of the balance spring or balance spring blank with a reference spectrum, so as to determine if the characteristic identified in step b. is an abnormal characteristic diverging by a predetermined difference from the same characteristic of the predetermined expected resonance frequency.

3. The test method according to claim 1, the balance spring having at least two predetermined expected resonance frequencies, wherein the frequency range is predetermined in order to cover said at least two predetermined expected resonance frequencies.

4. The test method according to claim 1, wherein the defect affecting the balance spring or balance spring blank is a defect modifying the expected resonance modes,
wherein step c. comprises a step consisting of searching for an abnormal resonance peak between two expected and normally adjacent or consecutive resonance peaks.

5. The test method according to claim 1, wherein the defect affecting the balance spring or balance spring blank is an attenuating or amplifying defect of the expected resonance modes,
wherein step c. comprises a step consisting of searching for an abnormal resonance peak with an amplitude that is different by at least 30% from an expected amplitude of an expected resonance peak.

6. The test method according to claim 1, wherein step b. is based on a measurement over time of a displacement amplitude or speed or acceleration, of at least one point of the balance spring or balance spring blank, preferably carried out at least partially during step a.

7. The test method according to claim 1, the balance spring or the balance spring blank being contained in a base plane, wherein step b. comprises:
a step b′ of measuring a displacement amplitude or speed or acceleration, of at least one point of the balance spring or balance spring blank in a direction perpendicular to the base plane, and/or
a step b″ of measuring a displacement amplitude or speed or acceleration, of at least one point of the balance spring or balance spring blank in a direction contained in the base plane.

8. The test method according to claim 6, wherein step b. comprises:
a step of identifying a resonance peak of the balance spring or balance spring blank as a function of a displacement amplitude or speed, of at least one point of the balance spring or balance spring blank.

9. The test method according to claim 8, wherein the characteristic of the resonance frequency is identified on the basis of the width of the resonance peak at half-height of the maximum value of the resonance peak.

10. The test method according to claim 1, wherein the prediction machine implements a classification carried out, for example, by a neural network in order to predict whether a defect affects the balance spring or the balance spring blank.

11. The test method according to claim 1, comprising a preliminary step consisting of taking into account the material of the balance spring or balance spring blank, and adjusting a maximum amplitude of the vibratory excitation and/or a frequency range of the predetermined frequency range as a function of the material of the balance spring or balance spring blank.

12. The test method according to claim 1, wherein the frequency range extends over a frequency range from 0 Hz to 100 kHz, preferably from 0 Hz to 50 kHz, more preferably from 0 Hz to 40 kHz, and very preferably from 10 KHz to 35 KHz.

13. The test method according to claim 1, wherein, if step c. determines that a defect affects the balance spring or the balance spring blank, then the method comprises at least one step consisting of identifying or isolating or reworking or discarding the balance spring or the balance spring blank.

14. A method for manufacturing a balance spring having at least one predetermined expected resonance frequency comprising the steps consisting of:
A/forming at least one balance spring or balance spring blank having dimensions within predetermined tolerances necessary for obtaining the predetermined expected resonance frequency,
B/testing the balance spring or the balance spring blank according to the testing method of claim 1.

15. The manufacturing method according to claim 14, comprising a step consisting of:
C/identifying or isolating or reworking or discarding the balance spring or balance spring blank formed during step A/, according to the defect identification in step c.

16. The manufacturing method according to claim 14, wherein the balance spring blank is formed on a wafer, with a plurality of other balance spring blanks.

17. A learning method for a prediction machine for implementing step c. of the testing method of claim 1, comprising the steps consisting of:
i—forming balance springs or balance spring blanks,
ii—applying, to each of the balance springs or each of the balance spring blanks, a vibratory excitation that varies over time in order to cover a predetermined frequency range,
iii—identifying at least one characteristic of a resonance frequency of each balance spring or each balance spring blank during the application of the predetermined frequency range,
iv′—installing a plurality of balance springs or balance spring blanks in an oscillating mechanism having a predetermined inertia, so as to measure a free oscillation frequency for each balance spring or balance spring blank, and/or
iv″—modelling, in a simulation tool, a plurality of balance springs or balance spring blanks in an oscillating mechanism having a predetermined inertia, so as to calculate a free oscillation frequency for each balance spring or balance spring blank,
v—deducing at least one expected resonance frequency of the resonance frequency identified in step iii-, and/or of the free oscillation frequency measured in step iv′—and/or calculated in step iv″—
vi—supplying to the prediction machine, and for each balance spring or blank:
the characteristic of the resonance frequency identified in step iii—;
the same characteristic of the expected resonance frequency.
